(19) United States
(12) Patent Application Publication
(10) Pub. No.: US 2008/0248829 A1
(43) Pub. Date: Oct. 9, 2008

(54) System and method for portable compatibility determination

(75) Inventors: Ran Zilca, Briarcliff Manor, NY (US); Ryan Osborn, Hoboken, NJ (US); David Rosenbloom, Nyack, NY (US); Tony Passera, South Nyack, NY (US)

Correspondence Address: KEUSEY, TUTUNJIAN & BITETTO, P.C., 20 CROSSWAYS PARK NORTH, SUITE 210, WOODBURY, NY, 11797, US

(73) Assignee: SIGNAL MATCH Inc.

(21) Appl. No.: 11/784,473

(22) Filed: Apr. 6, 2007

(51) Int. Cl. H04Q 7/00

(52) U.S. Cl. 455/552.1

(57) ABSTRACT

A system and method for portable compatibility determination includes a service computer configured to handle compatibility requests from mobile users. The service computer includes a messaging system configured to receive a request from a sender, decipher identifying information from the request for the sender and a subject person, and reply with a report to at least the sender. A matching engine is configured to associate a profile of the sender with available information to determine a compatibility measurement between the sender and the subject person. A report generator is configured to format the report based upon the compatibility measurement.

### BACKGROUND

1. Technical Field

The present invention relates to compatibility checking, and more particularly to systems and methods for checking compatibility between individuals using wireless technology.

2. Description of the Related Art

Many compatibility systems are located on websites. For a user to compare their personality to another user or service subscriber, the user has to log onto the system and navigate through the site to either find another individual with compatible information or conduct a search to find a user profile with desired characteristics.

These systems are in many ways limiting, since access to the website is necessary. There is no feature which can be employed in an actual social setting to check compatibility using portable devices.

### SUMMARY

A system and method for portable compatibility determination includes a service computer configured to handle compatibility requests from mobile users. The service computer includes a messaging system configured to receive a request from a sender, decipher identifying information from the request for the sender and a subject person, and reply with a report to at least the sender. A matching engine is configured to associate a profile of the sender with available information to determine a compatibility measurement between the sender and the subject person. A report generator is configured to format the report based upon the compatibility measurement.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for determining compatibility between a sender and a subject in a social or networking setting in accordance with one embodiment;

FIG. 2 is a block/flow diagram showing a system/method for determining compatibility between two subjects in a social or networking setting in accordance with one embodiment;

FIG. 3 is a diagram showing an illustrative report in accordance with one embodiment;

FIG. 4 is a block/flow diagram showing a system/method for determining compatibility between persons in a social or networking setting in accordance with one embodiment; and

FIG. 5 is a block/flow diagram showing a system/method for determining compatibility between persons in a social setting in accordance with another embodiment.

### DETAILED DESCRIPTION OF PREFERRED EMBODIMENTS

In accordance with the present principles, systems and methods for checking compatibility between users of a service are disclosed. Compatibility as used herein includes similarities and/or differences between two (or more) people, or entities. In accordance with one embodiment, a compatibility service is provided where an identifying number or name (ID) is associated with a user profile. In a social or other situation, when a user meets another individual, the user can obtain the individual's ID and submit the ID along with the user's ID to the service. This is preferably done using a cellular telephone or text messaging device, although other device may be employed. The service will then send the user a report or other requested information regarding the compatibility between the user and the individual. Advantageously, the information can be employed in real-time or with minimal delay to determine the compatibility of personalities, business profiles, social or other characteristics or areas of compatibility on location where the information is more useable and convenient.

In particularly useful embodiments, the user or users (first person) employ a cellular telephone or the like to text message a service provider. The text message may include a telephone number, a cellular telephone number and email address, or other ID of the person (second person) to whom the user would like a compatibility report. The service provider then deciphers the second person's information and associates this information to a stored profile or conducts a search for available information for the second person. The identity of the first person may be known as the result of caller ID or other telephone feature, or the first user may simply identify themselves.

The service provider constructs a compatibility report and sends it back to the first user for review. The report can be text messaged, emailed, etc. depending on the platform the inquiry was sent from. The report may include many different formats and may be configurable by the user/sender or may be selectable from a plurality of options.

If confidential or sensitive information of the second user is involved, a copy of the report or a notification may be sent to the second user to authorize access to a profile prior to a report being sent. Alternately, the second person may receive a notification that the first person has submitted a compatibility request. There may include an option for users to provide pre-permission to have their profiles accessed. In this option, without authorization, a message will be returned to the requested denying access. The permission to be matched may also be customized based upon the requester. For example, if the requester is under 18, permission is denied. This may be made applicable to a plurality of criteria, including age, sex, relationship status, etc.

It should be understood that the elements shown in FIGS. may be implemented in various forms of hardware, software or combinations thereof. Preferably, these elements are implemented in software on one or more appropriately programmed general-purpose digital computers having a processor and memory and input/output interfaces.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

The embodiments described herein make include a computer program product accessible from a computer-usable or computer-readable medium providing program code for use by or in connection with a computer or any instruction execution system. A computer-usable or computer readable medium can be any apparatus that may include, store, communicate, propagate, or transport a program for use by or in connection with the instruction execution system, apparatus, or device. Storage media may include electronic, magnetic, optical, electromagnetic, infrared, or semiconductor system (or apparatus or device) or a propagation medium. Examples of a computer-readable medium may include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Servers or other devices may be employed for data processing. A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (e.g., keyboards, displays, pointing devices, etc.) may be coupled to the system either directly or through intervening I/O controllers.

To enable the data processing system to become coupled to other data processing systems or remote printers or storage devices through intervening private or public networks, network adapters may be employed. Modems, cable modems and Ethernet cards are examples of network adapters.

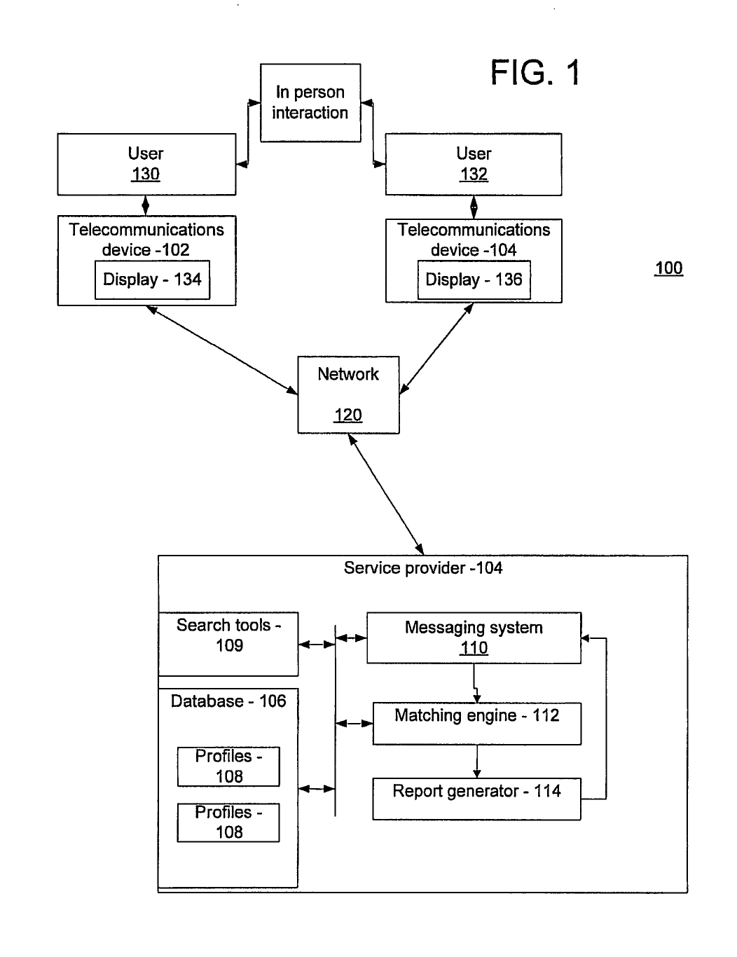

Referring now to the drawings in which like numerals represent the same or similar elements and initially to FIG. 1, a block/flow diagram illustratively shows an exemplary embodiment 100 to demonstrate the present principles. In this embodiment, a first user 130 meets a second user 132 in a social or business networking situation. During the course of in-person interaction, user 130 decides to determine whether user 130 is compatible with user 132. Compatibility may be based on a plurality of different criteria in a plurality of different relationship types of settings. In illustrative embodiments, compatibility categories may include personality, romance, business, religious beliefs, moral beliefs, business practices/types or any other type of compatibility. Compatibility may be based on one or more of these categories and specific items of information that may be important in a given situation.

In one embodiment, each user (e.g., user 130) may have a stored profile 108 stored at a service provider 104. Service provider 104 may provide a subscription or enrollment for users and permit users to answer questions or otherwise store profile information related to one or more compatibility categories. For example, in the personality category, the profile 108 may include information regarding the introverted or extroverted characteristics of a user, how a user would react to certain social situations or any other criteria that could be employed as a measure of personality. The categories may be business specific, e.g., one user sells cars and light trucks while a second user purchases these items. Compatibility categories may extend over a wide range of topics and may be customized by a service provider to permit a plurality of different compatibility scores or connections. Other options may be selected as well. For example, pre-permission settings and criteria may be selected.

Service provider 104 may include a server or other computing device which has the ability to communicate and process information requests and to send out reports. The service provider 104 may be accessible over a public or private network (120). The network may be wired or wireless and may include cable, telephone, satellite or any other media.

The present system is particularly useful when the two users are both enrolled with the service provider 104. The service provider 104 may be accessed over network 120. The network 120 may be the internet, a wide area network, etc. The network 120 may also be a local network where interactions are limited to a particular location such as a bar or night club. In this instance, all participants may be asked to fill out a profile 108 upon entry and interact with the service provider 104 locally in accordance with the present principles. In this instance, all attendees will have a profile on file and can remotely access the service provider for instant compatibility checks on a handled portable communications device. The device may be a telephone, a specialized/customized device, etc.

In the illustrative embodiment, two individuals 130 and 132 can be matched together. The service provider 104 includes a messaging system 110. Each user (e.g., user 130) attempting to access service provider 104 has an appropriate telecommunication device 102. The telecommunications device 102 may be broadly construed to include the following media types and the devices/structures to implement them: email, cell phone, BLACKBERRY™, Short Message Service (SMS) (cellular phone text messaging), internal messages on a website, voice messages, etc.

In a social setting user 130 meets user 132. User 130 obtains personal identification information from user 132. The personal identification information may include a telephone number, a name, a password, an ID number, a voice signature or any other identifying feature. User 130 sends the information of user 132 along with user 130's own identifying information to service provider 104. In one embodiment, the identifying information is a telephone number and the information is sent to service provider 104 by text messaging (e.g., using a cell phone). Messaging system 110 may be activated by dialing a designated telephone number, text messaging, emailing, etc.

Messaging system 110 receives the message, determines the sender's identification (user 130) and deciphers information about user 132. The request by user 130 is processed by the messaging system 110 which is configured to determine based on the context and format of the message how to decipher user 132's identifying information. Caller ID or similar technology may be employed to determine user 130's identifying information. Alternately, user 130 may input their own identifying information directly in to the message.

The messaging system 110 permits the transfer of text and media messages from one endpoint of the network 120 to the other. Email, instant messaging, and mobile text-messaging may all be options for the messaging system 104. User 130 (“the sending party” in this case) specifies a message and an address (and endpoint of the network—“the receiving party”) and the messaging system 110 at the specified endpoint receives this message.

The messaging system 110 can employ one or more different device types, for example, an email message can be sent to a laptop computer, a mobile phone, or a game console. Some messaging systems 110 can know the address of the sending party even if it is not specified explicitly. For example, a telephone system can have caller ID, and an email system keeps the sending party's email address so that the receiving party can easily reply. The messaging system 110 outputs the identities of user 130 and 132 to a matching engine 112.

Matching engine 112 associates each identity of the users 130 and 132 with their respective profile 108. These profiles may be compared on a plurality of different criteria which may be requested by the requesting user or the user may be prompted for specific criteria to check by the messaging system 110. The two user profiles 108 (or statistical models) are compared and similarities and dissimilarities are computed between them, including, e.g., a compatibility measure or a match score.

The matching engine 112 receives two user profiles 108 (or identities of two users that can be used to retrieve the user profiles 108) and performs a match operation. The match operation may result in more than one type of output. For example: a similarity score, the names and identifiers of user profiles' properties that are the closest between the two users, the properties least similar between the users, etc. One embodiment of the matching engine 112 may include a personality modeling system described in a commonly assigned US patent application, entitled “SYSTEM AND METHOD FOR CREATING AND USING PERSONALITY MODELS FOR USER INTERACTIONS IN A SOCIAL NETWORK”, Ser. No. 11/581,051, filed on Oct. 13, 2006, incorporated herein by reference.

In one embodiment, user 132 may not be a subscriber or have a profile 108 stored on the service provider's database 106. In this case, a profile may be obtained from a different location or public information may be obtained. For example, search tools 109 may be employed to search for compatibility information, for example, one the web or in public databases. Search tools 109 my include search engines and the like.

The matching engine 112 outputs the results of the comparison to a report generator 114. The report generator 114 takes the output generated by the engine 112, together with the information available in the profiles 108 of the two users, and creates a report that summarizes the compatibility between the two users 130 and 132. The report output is sent to the messaging system 110, which forwards the report to the device 102 of user 130. The report may be visually displayed on a display 134 or audible rendered on a telephone, text messaged, emailed, etc. The report may be a matrix of categories and display the magnitude of the compatibility for the user. In other embodiments, the report may simply be a word or phrase, such as “compatible” or “not compatible” or a match score, or may be a complex matrix with a plurality of different categories displaying numbers or match scores for levels or attributes between the users. The reports may be user customized or default formatted.

The report generator 114 can take the results returned from the match engine 112 and generate a report that can be interpreted and understood easily by users. For example, it may take the match score and color the background of a web page or display output based on the value of the match score. Another example is taking numerical results such as user attribute percentiles and explaining them in words (e.g. “Only 3% of the population matches in this category. You both like to speak your mind and do not hesitate to speak”).

The report may be sent to both user 130 and user 132. User 132 could review the report on their own telecommunications device 104, which may have all the features of device 102 (e.g., a display 136, speaker, etc.). Alternately, a notification that user 132 has been the subject of a compatibility request where their profile has been reviewed may be sent to device 104.

The request of the sender (user 130) may include identifying information for a second subject person in addition to user 132. The request may be for the compatibility between the subject person 132 and a second subject person. This could be reported to user 130, to user 130 and 132 or to all parties.

It should be understood that while the present embodiments are described in terms of portable handheld communication devices, non-portable device may also be employed (such as computer workstations, customized information stations or terminals, kiosks, etc.).

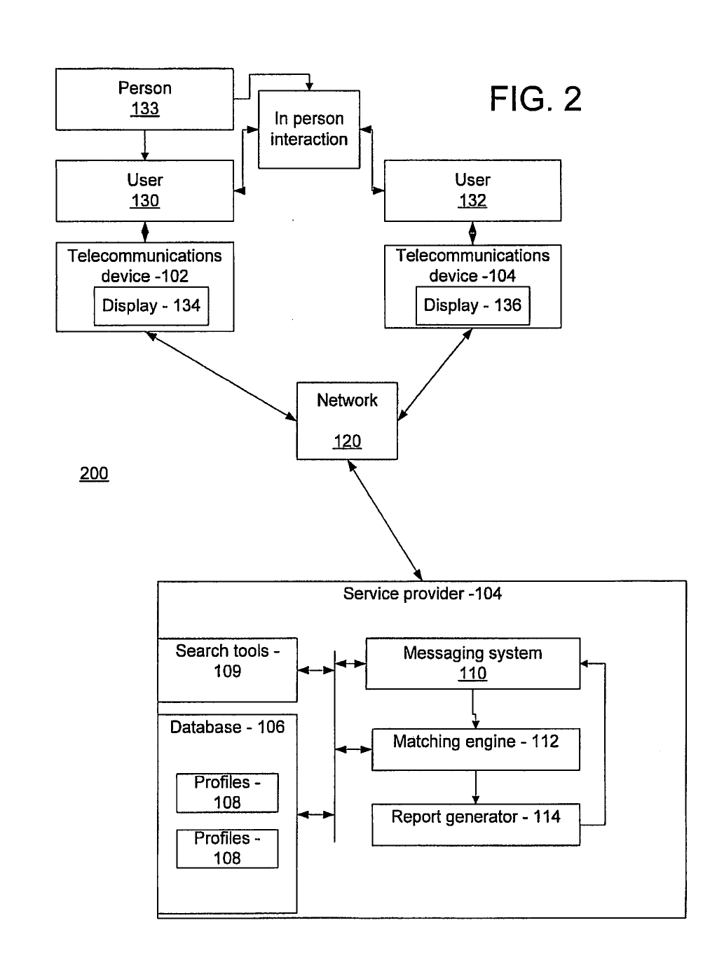

Referring to FIG. 2, another configuration is shown in accordance with an alternate embodiment. A system 200 may be adapted to permit a first user 130 to test the compatibility between two different users or persons. In one embodiment, user 130 wishes to get a compatibility score between user 132 and user 133. User 130 inputs and sends identifying information for users 132 and 133. Service provider 104 would then search for user profiles 108 associated with the identifying information, and test the compatibility as described above for matching engine 112. The report generated with the match score or compatibility score is sent to sender 130. The report may also be sent to user 132 and/or user 133.

In one useful embodiment, profiles for sports figures, celebrities, government officials, mythical characters may have stored profiles 108. A user 130 may decide to compare his favorite two pitchers based on pitching statistics, compare quarterbacks on passing statistics, compare top actors on highest yearly income or any other information that can be stored and compared in profiles.

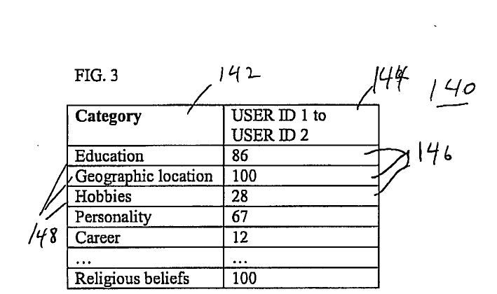

Referring to FIG. 3, a compatibility report 140 is illustratively in accordance with one embodiment. Report 140 may be displayed on a telephone screen or the like. Report 140 may include columns 142 and 144. Column 142 lists a plurality of comparison categories 148 while column 144 lists scores 146 for each category. In this example, column 144 includes a caption showing the parties for which the comparison has been performed. It should be understood that a plurality of different formats may be employed for report 140. For example, only categories that match above (or below) a threshold amount may be shown or certain pre-selected categories may be shown.

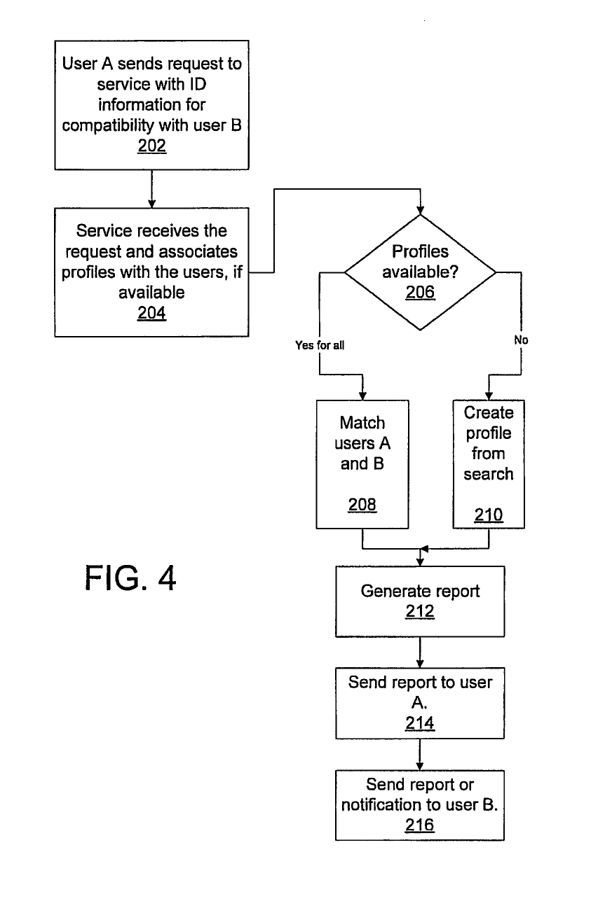

Referring to FIG. 4, a block/flow diagram showing an illustrative sequence of operations and events is depicted in a general embodiment. In block 202, user A sends a message to the service (using the messaging system) with a request to receive a report with respect to user B. The message includes identifying information for both user A and user B. In block 204, the service receives the request and associates the identifying information with user profiles. In block 206, a determination is made as to whether the user A and user B have a profile on file. If yes for both user A and user B, a matching engine compares the profiles in block 208. The two users are preferably enrolled in the service, and have a user profile. Otherwise, a profile is optionally generated or information is gathered by search tools in block 210 to substitute for the missing profile. The available information is submitted to the matching engine in block 208.

In block 212, a compatibility report is generated by a report generator based on the results coming from the matching engine. The compatibility report is sent to user A in block 214. The compatibility report or a notification may optionally be sent to user B in block 216. The report or notification may be sent to user B if the user B has a profile stored with the service. Such notification is an accommodation to user B to let user B know that someone has accessed their profile. In one embodiment, the notification may include instructions or information on how to subscribe to the service or how to list a profile with the service provider.

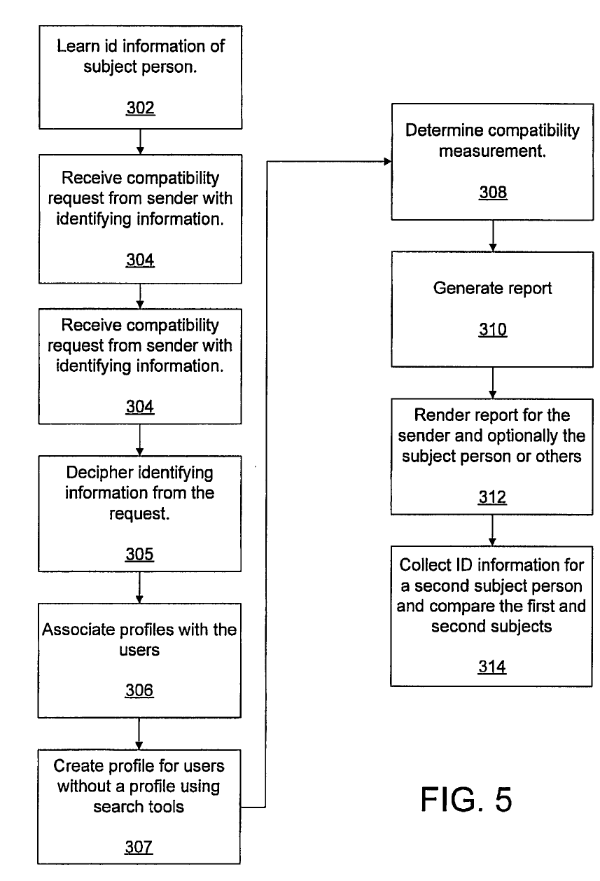

Referring to FIG. 5, a block/flow diagram shows a system/method for portable compatibility determination in accordance with the present principles. In block 302, identifying information of a subject person is learned by the sender preferably through face-to-face contact.

In block 304, a compatibility request is received from a sender using a portable handheld telecommunications device, wherein the request includes identifying information for the sender and for a subject person. The request may be in the form of a text message, a telephone call, an email, etc. The method identifying information is included in the request and may include a telephone number, email address, ID number, etc. of each of the sender and of the subject person.

In block 305, the identifying information from the request is deciphered from the request for association with user information profiles stored in a database. In block 306, the user information profile of the sender and the user information profile of the subject person are associated using the respective identifying information. The associating of the identifying information of the subject person may include retrieving public information associated with the subject person when a user information profile of the subject person is not available in block 307.

In block 308, a compatibility measurement is determined between the sender and the subject person. In block 310, a report is generated based upon the compatibility measurement. The report may be generated based upon a compatibility score computed using similar personality traits, and may include a listing of similarities between profiles.

In block 312, the report is displayed or rendered on the handheld telecommunications device of the sender. Alternately, the report is optionally sent to the subject person or a notification of the report is optionally sent to the subject person.

In block 316, identifying information for a second subject person is retrieved and compatibility between the subject person and the second subject person requested by the sender. This step may be performed instead or in addition to determining the compatibility between the sender and the first subject person.

An illustrative example of one preferred embodiment will now be described. User A meets user B in a bar. During the course of the conversation, user A decides to check his compatibility with user A. User A asks user B for her phone number. If a “caller ID” is available, user A text messages the service provider the telephone number of user B.

The service provider obtains user profiles of user A and user B, and generates a report. In general, the two users receive the report. This permits user B to know that user A was interested in the compatibility between them. It is also a safety feature allowing user B to know if there are other users that know user B's network address and are expressing interest in user B. If pre-permission was granted by user B then, user B's profile may be checked to determine if the criteria is met for checking compatibility.

In another embodiment, user A may receive an exclusive report (e.g., user B does not get a report). This could be a paid feature for premium users. Another premium feature could be user C, a third party, asking to know about the compatibility between users A and B.

If one or more users participating in the match are not enrolled in the service, they can receive an invitation to enroll in the service (for example, a link to a web URL). For example, if user A is enrolled and user B is not, user B will receive an invitation and user A will receive notification that user B is not enrolled and therefore the match cannot be performed.

In some cases both users may be enrolled, but not have all of the entries in their profile. This can result in a partial match report. In such a case, a report will be sent to the two parties, along with an invitation to add the missing data. For example, if both users A and B have personality data, but only user B has music preferences data, then the match report will be based on personality only, and, user A will receive an invitation to enter their music preferences, and user A and B will be notified in the report that no music match is possible since user A's profile is missing this entry.

Having described preferred embodiments of a system and method for portable compatibility determination (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A system for portable compatibility determination, comprising:
a service computer configured to handle compatibility requests from mobile users, the service computer including:
a messaging system configured to receive a request from a sender, decipher identifying information from the request for the sender and a subject person, and reply with a report to at least the sender;
a matching engine configured to associate a profile of the sender with available information to determine a compatibility measurement between the sender and the subject person; and
a report generator configured to format the report based upon the compatibility measurement.

2. The system as recited in claim 1, wherein the request is a text message.

3. The system as recited in claim 1, wherein the request is one of a telephone call, and an email.

4. The system as recited in claim 1, wherein the identifying information is included in the request and includes a telephone number of each of the sender and of the subject person.

5. The system as recited in claim 1, wherein the sender learns of identifying information about the subject person through face-to-face contact.

6. The system as recited in claim 1, wherein the report includes a compatibility score.

7. The system as recited in claim 1, wherein the service computer includes a database for storing an information profile of at least the sender and the identifying information is associated with the profile.

8. The system as recited in claim 7, wherein the database stores an information profile of the subject person and the identifying information of the subject person is associated with the profile of the subject person.

9. The system as recited in claim 7, wherein the identifying information of the subject person is employed to retrieve public information associated with the subject person.

10. The system as recited in claim 1, wherein the request of the sender includes identifying information for a second subject person and the request includes a request for compatibility between the subject person and the second subject person.

11. The system as recited in claim 1, wherein the report is sent to the subject person.

12. The system as recited in claim 1, wherein a notification of the report is sent to the subject person.

13. The system as recited in claim 1, wherein the subject person does not have a profile and the notification of the report includes an invitation to provide a profile.

14. A system for portable compatibility determination, comprising:
a service computer configured to handle compatibility requests from mobile users, the service computer including:
a messaging system configured to receive a request from a sender, decipher identifying information from the request for a first subject person and a second subject person, and reply with a report to at least the sender;
a matching engine configured to associate a profile of the first subject person and the second subject person to determine a compatibility measurement between the first subject person and the second subject person; and
a report generator configured to format the report based upon the compatibility measurement.

15. A method for portable compatibility determination, comprising:
receiving a compatibility request from a sender using a portable handheld telecommunications device, wherein the request includes identifying information for the sender and for a subject person;
deciphering the identifying information from the request to associate with user information profiles for the sender and the subject person;
associating the user information profile of the sender and the user information profile of the subject person using the respective identifying information;
determining a compatibility measurement between the sender and the subject person;
generating a report based upon the compatibility measurement; and
replying with the report on the handheld telecommunications device of the sender.

16. The method as recited in claim 15, wherein the request is a text message.

17. The method as recited in claim 15, wherein the request is one of a telephone call, and an email.

18. The method as recited in claim 15, wherein the identifying information is included in the request and includes a telephone number of each of the sender and of the subject person.

19. The method as recited in claim 15, further comprising learning the identifying information of the subject person by the sender through face-to-face contact.

20. The method as recited in claim 15, wherein generating includes generating the report based upon a compatibility score computed based on similar personality traits.

21. The method as recited in claim 15, wherein generating includes generating a listing of similarities between profiles.

22. The method as recited in claim 15, wherein associating includes associating the identifying information of the subject person to retrieve public information associated with the subject person when a user information profile of the subject person is not available.

23. The system as recited in claim 15, further comprising identifying information for a second subject person and requesting compatibility between the subject person and the second subject person.

24. The method as recited in claim 15, further comprising sending the report to the subject person.

25. The method as recited in claim 15, further comprising sending a notification of the report to the subject person.

26. The method as recited in claim 15, wherein sending a notification of the report to the subject person includes sending an invitation to provide a profile to a non-enrolled subject person.

27. A computer program product comprising a computer useable medium including a computer readable program, wherein the computer readable program when executed on a computer causes the computer to perform the steps of claim 15.

28. A method for portable compatibility determination, comprising:
receiving a compatibility request from a sender using a portable handheld telecommunications device, wherein the request includes identifying information for a first subject person and a second subject person;
deciphering the identifying information from the request to associate with user information profiles for the first subject person and the second subject person;
associating the user information profile of the first subject person and the user information profile of the second subject person using the respective identifying information;
determining a compatibility measurement between the first subject person and the second subject person;
generating a report based upon the compatibility measurement; and
replying with the report on the handheld telecommunications device of the sender.
